(19) United States
(12) Patent Application Publication
(10) Pub. No.: US 2024/0378491 A1
(43) Pub. Date: Nov. 14, 2024

(54) SYSTEMS AND METHODS FOR USING HASH TABLES FOR GENERATING TEXTUAL PREDICTION EXPLANATIONS

(71) Applicant: Capital One Services, LLC, McLean, VA (US)

(72) Inventors: Brian BARR, Schenectady, NY (US); Samuel SHARPE, Cambridge, MA (US); Christopher Bayan BRUSS, Washington, DC (US); Nikita SELEZNEV, McLean, VA (US)

(73) Assignee: Capital One Services, LLC, McLean, VA (US)

(21) Appl. No.: 18/315,476

(22) Filed: May 10, 2023

(51) Int. Cl. G06N 20/00

(52) U.S. Cl. CPC G06N 20/00

(57) ABSTRACT

Systems and methods for using hash tables generating textual prediction explanations. In some aspects, the system receives a first plurality of user profiles and a corresponding plurality of resource availability values. Each user profile includes values for a first set of features. The system processes a first machine learning model to extract an explainability vector. The first machine learning model receives as input the first set of features and outputs a resource availability value. The system, using the explainability vector, selects a subset of features having corresponding values in the explainability vector above a threshold. The system generates a set of categories based on the subset of features and a hash table including the set of categories. The hash table is indexable using a hash value generated based on values for the subset of features. The system transmits to a user system corresponding a user profile a textual prediction explanation.

### SUMMARY

Methods and systems are described herein for novel uses and/or improvements to artificial intelligence applications. As one example, methods and systems are described herein for generating hash tables using explainability techniques that describe the effect of variables in a first model. The hash tables place user profiles into categories corresponding to classification explanations. An explainability vector may be extracted from the machine learning model where each entry in the explainability vector may correspond to a feature and be indicative of a correlation between the feature and the output of the first machine learning model. The explainability vector may be used to generate an alternative set of features than those of the first model. The alternative set of features may be used to encode user profiles into approximate signatures. Approximate signatures allow the hash table to generate hash values which correspond to textual prediction explanations.

Conventional systems have not contemplated leveraging an explainability vector for explaining the prediction results of a machine learning model. For example, an explainability vector for a first machine learning model for predicting resource availability may shed light on which input factors correlate more, or less, with predicted resource availability. Therefore, the explainability model is useful when providing users with explanations of which factors led the first machine learning model to determine the resource availability score that it did. Using explainability vectors in generating textual prediction explanations provides the practical benefit making use of explainability vectors to expediently and accurately generate human-readable prediction explanations than other methods.

The difficulty in adapting artificial intelligence models for this practical benefit faces several technical challenges such as how to process the explainability vector in preparation for feature extraction, how to select a subset of features, and how to use hash values in combination with approximate signatures based on the subset of features to place user profiles into categories. To overcome these technical deficiencies in adapting artificial intelligence models for this practical benefit, methods and systems disclosed herein extract explainability vectors from machine learning models which describes importance of parameters to a first model. The explainability vectors are then used to select a subset of features. The features may be selected for explanative power and/or some other criterion. The system may generate approximate signatures of user profiles using the subset of features. The approximate signatures are used to in a hash table to generate hash values for user profiles which place them into categories, the categories corresponding to textual explanations of predictions by the first model. Thus, methods and systems disclosed herein make use of explainability vectors to direct the generation of textual prediction explanations.

In some aspects, methods and systems are described herein comprising: receiving, for a first plurality of user systems, a first plurality of user profiles and a corresponding plurality of resource availability values, wherein each user profile includes values for a first set of features; processing a first machine learning model to extract an explainability vector, wherein the first machine learning model receives as input values for the first set of features and generates as output a corresponding resource availability value; using the explainability vector, selecting from the first set of features a subset of features having corresponding values in the explainability vector above a threshold; generating a set of categories based on the subset of features, wherein each category in the set of categories corresponds to one or more textual prediction explanations for the output of the first machine learning model; generating a hash table including the set of categories, wherein the hash table is indexable using a hash value generated based on values for the subset of features for a user system; and for a user profile processed using the first machine learning model to generate a corresponding resource availability value, transmitting to a user system corresponding to the user profile a notification comprising a textual prediction explanation retrieved from the hash table using a hash value generated based on values of the subset of features from the user profile.

Various other aspects, features, and advantages of the systems and methods described herein will be apparent through the detailed description and the drawings attached hereto. It is also to be understood that both the foregoing general description and the following detailed description are examples and are not restrictive of the scope of the systems and methods described herein. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for a system for generating textual prediction explanations, in accordance with one or more embodiments.

FIG. 2 shows a hash table generating hash values for user profiles, in accordance with one or more embodiments.

FIG. 3 shows illustrative components for a system for generating textual prediction explanations, in accordance with one or more embodiments.

FIG. 4 shows a flowchart of the steps involved in generating textual prediction explanations, in accordance with one or more embodiments.

### DETAILED DESCRIPTION

In the following description, for the purposes of explanation, numerous specific details are set forth in order to provide a thorough understanding of the embodiments described herein. It will be appreciated, however, by those having skill in the art that the embodiments may be practiced without these specific details or with an equivalent arrangement. In other cases, well-known structures and devices are shown in block diagram form in order to avoid unnecessarily obscuring the embodiments.

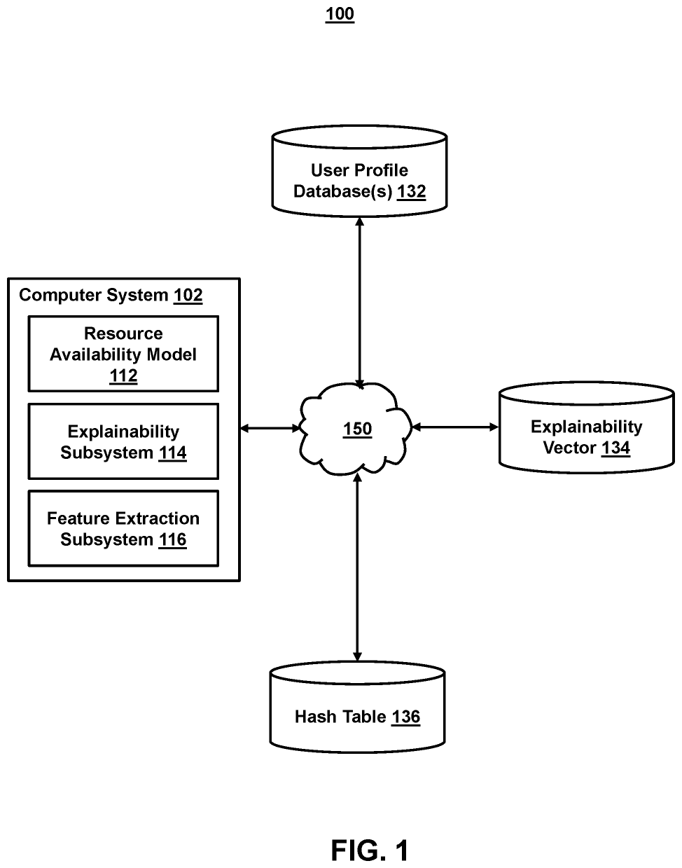

FIG. 1 shows an illustrative diagram 100 for system 150, which contains hardware and software components used to select similar user systems and recommend actions which reduce resource consumption, in accordance with one or more embodiments. For example, Computer System 102, a part of system 150, may include Resource Availability Model 112, Explainability Subsystem 114, and Feature Extraction Subsystem 116.

System 150 (the system) may retrieve a plurality of user profiles from User Profile Database(s) 132. Each user profile in User Profile Database(s) 132 corresponds to a user system, and contains information described by a first set of features. The first set of features may contain categorical or quantitative variables, and values for such features may describe, for example, a length of time for which the user system has recorded resource consumption, an extent and frequency of resource consumption, and the number of instances of the user system's excessive resource consumption. Each user profile may correspond to a resource availability value indicating the current allowance of resources assigned to the user system, which may also be recorded in User Profile Database(s) 132 in association with the user profile. The system may retrieve a plurality of user profiles as a matrix including vectors of feature values for the first set of features, and append to the end of each vector a resource availability value.

In some embodiments, the system may, before retrieving user profiles, process User Profile Database(s) 132 using a data cleansing process to generate a processed dataset. The data cleansing process may include removing outliers, standardizing data types, formatting and units of measurement, and removing duplicate data. The system may then retrieve vectors corresponding to user profiles from the processed dataset.

The system may train a first machine learning model (e.g., Resource Availability Model 112) based on a matrix representing the plurality of user profiles. Resource Availability Model 112 may take as input a vector of feature values for the first set of features and output a resource availability score indicating an amount of resources that should be assigned to a user system with such feature values as the input. Resource Availability Model 112 may use one or more algorithms like linear regression, generalized additive models, artificial neural networks or random forests to achieve quantitative prediction. The system may partition the matrix of user profiles into a training set and a cross-validating set. Using the training set, the system may train Resource Availability Model 112 using, for example, the gradient descent technique. The system may then cross-validate the trained model using the cross-validating set and further fine-tune the parameters of the model. Resource Availability Model 112 may include one or more parameters that it uses to translate input into outputs. For example, an artificial neural network contains a matrix of weights, each weight in which is a real number. The repeated multiplication and combination of weights transform input values to Resource Availability Model 112 into output values.

The system may use Explainability Subsystem 114 to extract an explainability vector (e.g., Explainability Vector 134) from Resource Availability Model 112. Explainability Subsystem 114 may employ a variety of explainability techniques depending on the algorithms in Resource Availability Model 112 to extract Explainability Vector 134. Explainability Vector 134 contains one entry for each feature in the set of features in the input to Resource Availability Model 112, and the entry reflects the importance of that feature to the model. The values within Explainability Vector 134 additionally represent how each features correlates to the output of the model, and the causative effect of each feature in producing the output as construed by the model. In some embodiments, a correlation matrix may be attached to Explainability Vector 134. The correlation matrix captures how variables are correlated with other variables. This is relevant because correlation between variables in a model causes interference in their causative effects in producing the output of the model.

To extract Explainability Vector 134 from Resource Availability Model 112, Explainability Subsystem 114 may retrieve a first set of parameters describing Resource Availability Model 112 and select an attribution technique based on the first set of parameters and the first plurality of user profiles. The attribution technique may be tailored to Resource Availability Model 112, since certain attribution techniques are more suitable for particular models. Explainability Vector 134 then applies the attribution technique to the first set of parameters to generate the explainability vector corresponding to the first set of features. Below are some examples of how Explainability Subsystem 114 selects and applies attribution techniques to various embodiments of Resource Availability Model 112 to extract Explainability Vector 134.

For example, Resource Availability Model 112 may contain a matrix of weights for a multivariate regression algorithm. Explainability Subsystem 114 may use a Shapley Additive Explanation method to extract Explainability Vector 134. Shapley Additive Explanation computes Shapley values in coalitional game theory, treating each feature in the input features of a model as participants in a coalition. Each feature therefore gets assigned a Shapley value capturing their contribution to producing the prediction of the model. The magnitude of Shapley values of each feature is then normalized. Explainability Vector 134 may be a list of normalized Shapley values of each feature.

In another example, Resource Availability Model 112 may contain a vector of coefficients for a generalized additive model. Since the nature of generalized additive models is such that the effect of each variable on the output is completely and independently captured by its coefficient, Explainability Subsystem 114 may take the list of coefficients to be Explainability Vector 134.

In another example, Resource Availability Model 112 may contain a matrix of weights for a supervised classifier algorithm. Explainability Subsystem 114 may use a Local Interpretable Model-agnostic Explanations method to extract Explainability Vector 134. The Local Interpretable Model-agnostic Explanations approximates the results of Resource Availability Model 112 with an explainable model, e.g., a decision tree classifier. The approximate model is trained using a loss heuristic that judges similarity to Resource Availability Model 112 and that penalizes complexity. In some embodiments, the number of variables that the approximate model uses can be specified. The approximate model will clearly define the effect of each feature on the output: for example, the approximate model may be a generalized additive model.

In another example, Resource Availability Model 112 may contain a matrix of weights for a convolutional neural network algorithm. Explainability Subsystem 114 may use a Gradient Class Activation Mapping method to extract Explainability Vector 134. The Grad-CAM technique performs backpropagation on the output of the model with respect to the final convolutional feature map to compute derivatives of features in the input with respect to the output of the model. The derivatives may then be used as indications of importance of features to a model, and Explainability Vector 134 may be a list of such derivatives.

In another example, Resource Availability Model 112 may contain a set of parameters comprising a hyperplane matrix for a support vector machine algorithm. Explainability Subsystem 114 may use a counterfactual explanation method to extract Explainability Vector 134. The counterfactual explanation method looks for input data which are identical or extremely close in values for all features except one. Then the difference in prediction results may divided by the difference in the divergent value. This process is repeated on each feature for all pairs of available input vectors, and the aggregated result is a measure for the effect of each feature on the output of the model, which may be formed into Explainability Vector 134.

After extracting Explainability Vector 134 from Resource Availability Model 112, the system may use Explainability Vector 134 to select a subset of features from the set of features. To do this, the system may in some embodiments process the explainability vector using one or more filtering criteria to adjust the values corresponding to certain features. In some embodiments, these adjustments may be performed in response to a user request. For example, the system may receive a user request specifying that a subset of features be removed from consideration or that impact of the subset of features be reduced. In one example embodiment, the system may receive user profiles representing applicants for credit cards. A feature in the set of features may be the race or ethnicity of the applicant. The user may wish to exclude such features from consideration. Therefore, a subset of features to be removed may include, e.g., race and gender. The system may, in addition, calculate a threshold for removing features of the explainability vector. In some embodiments, the threshold may correspond to a pre-set real number, e.g., 0.45. In other embodiments, the system may simply remove the bottom 10% of features ranked by values in the explainability vector. Using the threshold, the system may add features to the subset of features to be removed. The system may apply a mathematical transformation to the explainability vector such that values corresponding to the subset of features are adjusted. For example, the values in the explainability vector for the subset of features may be set to zero, or the values may be halved. After removing and modifying features from the explainability vector, the remaining entries in the explainability vector may correspond to the selected subset of features.

In some embodiments, the system may use a method in addition to or in place of the above selection to generate the subset of features. The system may normalize Explainability Vector 134 into a standard-deviation space to produce a processed vector. Then, with reference to the correlation matrix attached to Explainability Vector 134, the system may generate a covariance matrix based on the processed vector. The covariance matrix captures how the effects on the output of the model of one or more features correlate. Using the covariance matrix, Feature Extraction Subsystem 116 may compute a set of eigenvectors and eigenvalues for the covariance matrix (e.g., through the Singular Value Decomposition method). Each eigenvector corresponds to an eigenvalue and represents a feature in the first set of features. The relative proportions of the eigenvalues are directly correlated with the magnitude of a factor's explanative weight in Resource Availability Model 112. By normalizing the eigenvalues of all features in the first set of features, the system may determine what percentage of the explanative power of the model may be captured by each feature. The system may then select a measure of coverage (e.g., a threshold percentage of the explanative power of the model). Using the measure of coverage, the system may select a subset of eigenvectors from the set of eigenvectors. For example, if the measure of coverage is 55%, and three eigenvectors' eigenvalues add up to 56% when normalized, the system may select the three eigenvectors. The system may then determine the second set of features to correspond to the subset of eigenvectors.

The system may then generate a set of categories based on the subset of features. Each category in the set of categories corresponds to one or more textual prediction explanations for the output of the first machine learning model. The set of categories may assign to each textual prediction explanation a range of real values. For example, if a model for textual explanations for college application decisions concludes that an application was accepted due to performance in extracurricular activities, “extracurricular activities” may be a category in the set of categories. The system may determine a range of real values to assign to this category, e.g., 0.1336 to 0.1992. For the above model, other categories (e.g., “personal statement”) may similarly correspond to their respective real value ranges (e.g., 0.887 to 0.996). The real value ranges may be used to populate a hash table (e.g., Hash Table 136) with the set of categories such that a hash value to fall into a real value range assigned to a category is associated with that category.

The system may generate a hash table (e.g., Hash Table 136) including the set of categories. The hash table may be indexable using a hash value generated based on values for the subset of features for a user system. The hash values may be used to identify a category from the set of categories with which the user profile may be associated. To generate Hash Table 136, which may include rules on translating input features into hash values, the system may transform the subset of features into signatures in a real-valued vector space. The encoding map may be a series of rules and transformations that take a vector of values for the subset of features, applies mathematical transformations like weight multiplications and Boolean combinations to the vector of values, and produces an output vector (e.g., a signature corresponding to the input vector of values). For example, an input vector of the values [23, 0.7, 100, 66, 80.4] may be taken into an encoding map. The encoding map may multiply the first feature by 1.774 to obtain the first output value. The encoding map may determine whether the second feature is greater than 0.5: if it is, the second output value is set to 1 and if not, it is set to 0. The encoding map may calculate a difference between the third and fourth features (e.g., 34) to be the third output value. The encoding map may ignore the fifth feature. Thus, the encoding map in this example takes an input vector of [23, 0.7, 100, 66, 80.4] and outputs a signature [40.802, 1, 34]. The system may use an encoding map to transform the first plurality of user profiles into a plurality of signatures in the real-valued vector space. In some embodiments, random permutations may be performed on the plurality of signatures. For example, a vector of random noise terms may be generated by drawing from statistical distributions. The vector of random noise terms may be added or multiplied to the plurality of signatures to generate a plurality of approximate signatures. In some embodiments, the system may randomly choose one or more terms from a signature to generate an approximate signature consisting only of those terms.

The system may then compare the plurality of approximate signatures. Since all approximate signatures are in the same real-valued space, the system may compute a distance (e.g., Euclidean distance or cosine similarity) between one or more pairs of approximate signatures. The system may record a distribution of distances between approximate signatures. The system may select a distance threshold, for example, as a percentile in the distribution of distances. The system may compute measures of similarity between each pair of approximate signatures as being, for example, inversely proportional to the distance between the pair. The system may then compare measures of similarity against a similarity threshold (e.g., an inverse of the distance threshold) to arrange approximate signatures into clusters. In some embodiments, the selection of the similarity threshold may be performed by a clustering algorithm which automatically generates clusters using, for example, K-means computation. With each approximate signature assigned to a cluster among one or more clusters, each user profile may be assigned a hash value corresponding to the approximate signature and the cluster.

The system may train an associative model to assign hash values to user profiles using their approximate signatures. The model may take as input a vector of values for the subset of features for a user profile (the feature vector), an approximate signature corresponding to the user profile, a cluster that the user profile's approximate signature was assigned to, and measures of similarity between the approximate signature and other approximate signatures. The associative model may output a hash value which falls into the real-value range of a category in the set of categories. The associative model may be trained on supervised training data from real applications of the system in generating textual prediction explanations. For example, for a user profile corresponding to a particular set of inputs, the correct category to place the user profile into had a hash value range of [0.887, 0.996]. During model training, any hash value output by the associative model between [0.887, 0.996] may be treated as a correct prediction. In some embodiments, the system may use more precise standards of accurate prediction when training the associative model. For example, the system may train the associative model using a loss function capturing the distance of the output from the center of the hash value range of the correct category. The associative model may use an algorithm like linear regression, random forest, naïve Bayes, among other algorithms.

Using the hash table, the system may assign a user profile to a textual prediction explanation. The user profile's approximate signature may be used to generate a hash value with Hash Table 136. The hash value may place the user profile into a category. The category corresponds to a textual prediction explanation. The textual prediction explanation may then be transmitted as, e.g., a text message to a user device. In some embodiments, the system may use pre-generated text templates for each category in the set of categories in the notifications transmitted communicating textual prediction explanations.

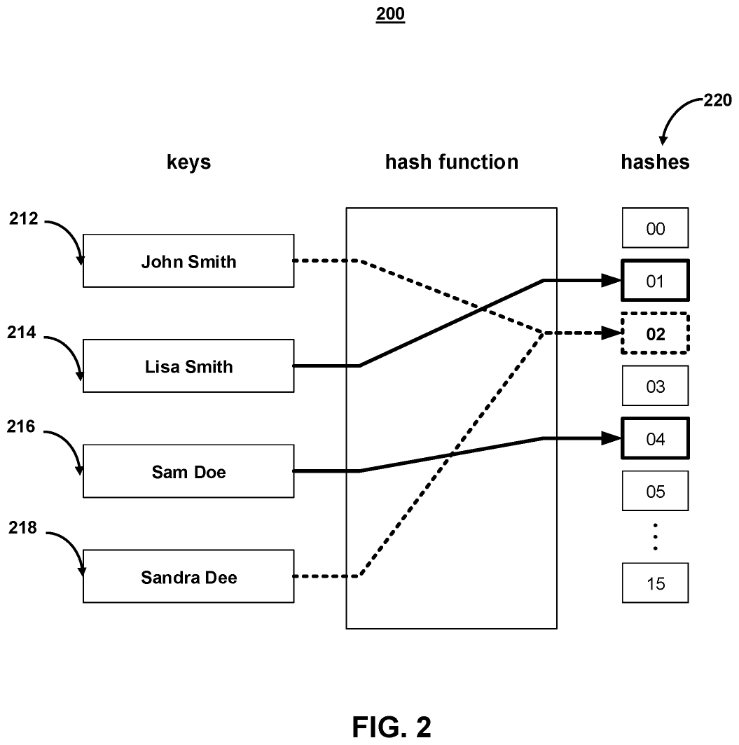

FIG. 2 is a demonstrative diagram 200 of user profiles being translated into hashes (hash values). A hash algorithm takes in keys and processes keys using a hash function to generate hashes, each key corresponding to a hash. In the current invention, keys are derived from user profiles using the subset of features. Using the encoding map described above, the system may take a vector of values for the subset of features corresponding to a user profile and transform the vector using a set of deterministic rules to output a signature. Signatures thus generated can be compared in a uniform signature space. In some embodiments, random permutations may be performed on signatures to generate approximate signatures also representing user profiles since approximate signatures may allow for faster computation. The keys of the hash table (e.g., Hash Table 136) may be signatures, or approximate signatures where used.

The system may then compare the plurality of signatures or approximate signatures to determine similarity between the user profiles they represent. For example, the system may compute distance metrics between each pair of approximate signatures and use a clustering algorithm to divide the plurality of approximate signatures into clusters. The hash function of Hash Table 136 may be a machine learning model which assigns hash values to user profiles using their approximate signatures. In particular, Hash Table 136 may use an associative model which takes as input a vector of values for the subset of features for a user profile (the feature vector), an approximate signature corresponding to the user profile, a cluster that the user profile's approximate signature was assigned to, and measures of similarity between the approximate signature and other approximate signatures. The associative model may output a hash value. The hash value may in some embodiments be rounded to the closest integer or be generalized to a value indicating a category assignment.

As an example of the hash table in action, four keys of approximate signatures representing user profiles are shown. Approximate signature 212 represents a user profile associated with John Smith, approximate signature 214 represents a user profile associated with Lisa Smith, approximate signature 216 represents a user profile associated with Sam Doc, and approximate signature 218 represents a user profile associated with Sandra Dee. The associative model may assign each approximate signature a hash from among hashes 220 in Hash Table 136 (representing the set of categories). For example, John Smith is assigned a hash of 02, Lisa Smith a hash of 01, Sam Doc a hash of 04, and Sandra Dee also a hash of 02. Multiple users may be assigned the same hash value. In some embodiments, hash values may be real numbers that are rounded or simplified to a nearest category.

The hashes, through their correspondence to categories, indicate textual prediction explanations for user features. For example, the user profiles in this case may represent credit card applications. Features of these applications may include income, credit history, location, revolving utilization and other such features. When a credit card application is declined, categories for turn down reasons may include insufficient income, insufficient length of credit history, and excessive revolving utilization. Of the hashes shown in FIG. 2, 01 may correspond, for example, to insufficient income, the reason that Lisa Smith was declined. John Smith and Sandra Dee's applications may both be declined due to, for example, excessive revolving utilization, the textual prediction explanation corresponding to a hash of 02. Sam Doe may be declined from insufficient length of credit history and hence be assigned a hash of 04. The system may then use hashes corresponding to user profiles to determine the explanative notifications which may be sent to them. Each hash may correspond to a template for notifications explaining reasons for rejection and may include suggestions on how to improve features in the user profile (e.g., build a lengthier credit history).

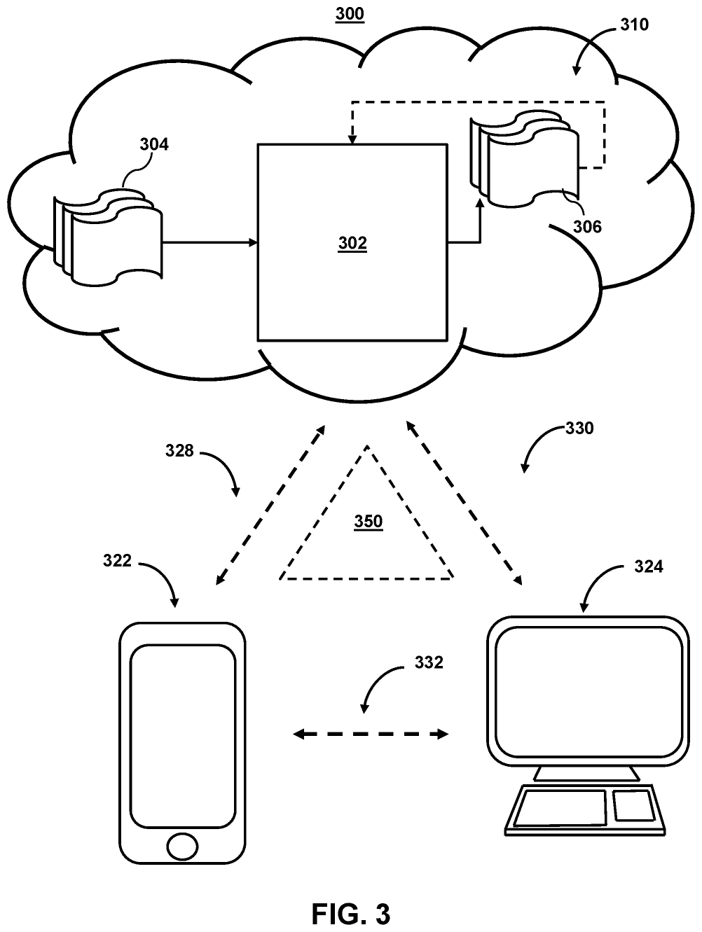

FIG. 3 shows illustrative components for a system used to communicate between the system and user devices and collect data, in accordance with one or more embodiments. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays, and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media, such as a non-transitory computer-readable medium, that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., predicting resource availability scores for user profiles).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302 (e.g., predicting resource availability scores for user profiles).

In some embodiments, the model (e.g., model 302) may automatically perform actions based on outputs 306. In some embodiments, the model (e.g., model 302) may not perform any actions. The output of the model (e.g., model 302) may be used to predict predicting resource availability scores for user profiles).

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their modules. API layer 350 may use a developer portal. API layer 350 may use strong security constraints applying WAF and DDoS protection, and API layer 350 may use RESTful APIs as standard for external integration.

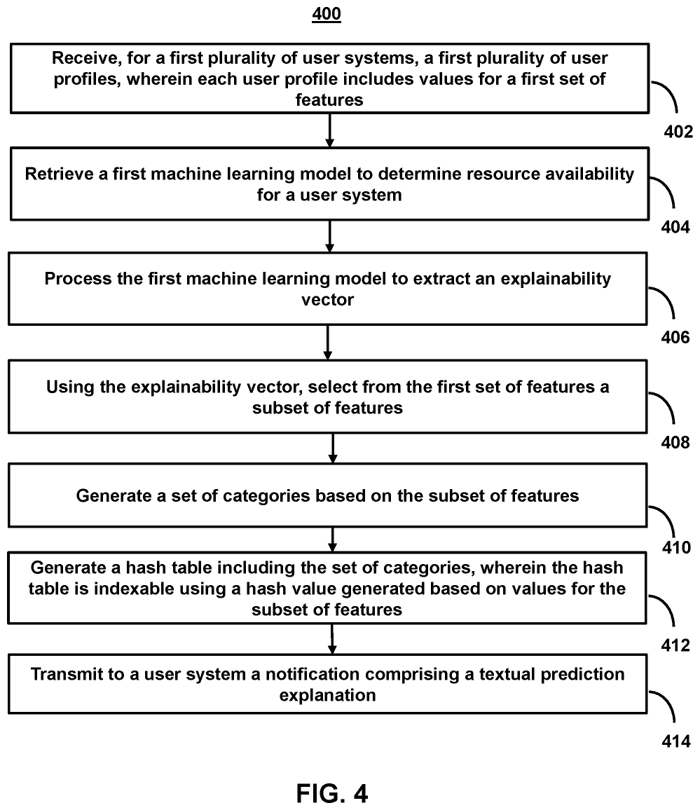

FIG. 4 shows a flowchart of the steps involved in generate recommendations for reducing resource consumption, in accordance with one or more embodiments. For example, the system may use process 400 (e.g., as implemented on one or more system components described above) in order to collect and process data about a user system, select similar user systems, and select among a plurality of actions that reduce resource consumption for the user system.

At step 402, process 400 (e.g., using one or more components described above) may receive, for a first plurality of user systems, a first plurality of user profiles, wherein each user profile includes values for a first set of features. For example, the system may use one or more software components (e.g., application programming interfaces) to browse User Profile Database(s) 132 and retrieve a dataset each entry for which corresponds to a user. A user profile is described by values in the first set of features. The first set of features may include quantitative or categorical variables. For example, the first set of features may include length of credit history, revolving credit utilization, credit lines and types of credit for a dataset relating to the creditworthiness of individuals. In some embodiments, the system may process the dataset of user profiles or User Profile Database(s) 132 using a data cleansing process to generate a processed dataset. The data cleansing process may include removing outliers, standardizing data types, formatting and units of measurement, and removing duplicate data. By collecting high-quality user profile data, the system may fully inform models that determine resource availability for user systems.

At step 404, process 400 (e.g., using one or more components described above) may retrieve a first machine learning model to determine resource availability for a user system. In some embodiments, the system may train the first machine learning model. To do so, the system may retrieve one or more user profiles from User Profile Database(s) 132 and combine corresponding resource availability values with the user profiles to generate a dataset. The dataset may then be divided into a training set and a cross-validating set. The system may train the first machine learning model (e.g., Resource Availability Model 112) using the training set and tune parameters using the cross-validating set. The first machine learning model receives as input values for the set of features within User Profile Database(s) 132 and generates as output a corresponding resource availability value.

At step 406, process 400 (e.g., using one or more components described above) may process the first machine learning model to extract an explainability vector. To do so, the system may use Explainability Subsystem 114. For example, if the first machine learning model is defined by a set of parameters comprising a matrix of weights for a multivariate regression algorithm, the explainability vector may be extracted from the set of parameters using the Shapley Additive Explanation method. For example, if the first machine learning model is defined by a set of parameters comprising a matrix of weights for a supervised classifier algorithm, the explainability vector may be extracted from the set of parameters using the Local Interpretable Model-agnostic Explanations method. For example, if the first machine learning model is defined by a set of parameters comprising a vector of coefficients for a generalized additive model, the explainability vector may be extracted from the vector of coefficients in the generalized additive model. For example, if the first machine learning model is defined by a set of parameters comprising a matrix of weights for a convolutional neural network algorithm, the explainability vector may be extracted from the set of parameters using the Gradient Class Activation Mapping method. For example, if the first machine learning model is defined by a set of parameters comprising a hyperplane matrix for a support vector machine algorithm, the explainability vector may be extracted from the set of parameters using the counterfactual explanation method. The explainability vector thus extracted (e.g., Explainability Vector 134) has the same number of entries as features in the first set of features. Each entry in this explainability vector represents the impact that a particular feature has on the model output.

At step 408, process 400 (e.g., using one or more components described above) may, using the explainability vector, select a subset of features from the first set of features. The system (e.g., Feature Extraction Subsystem 116) may process the explainability vector to rearrange the first set of features into a second set of features. For example, Feature Extraction Subsystem 116 may process the explainability vector using one or more filtering criteria to adjust the values corresponding to certain features. For example, the system may receive a user request specifying that a subset of features be removed from consideration or that impact of the subset of features be reduced. In one example embodiment, the system may receive user profiles representing applicants for credit cards. A feature in the set of features may be the race or ethnicity of the applicant. The user may wish to exclude such features from consideration. Therefore, a subset of features to be removed may include, e.g., race and gender. Feature Extraction Subsystem 116 may, in addition, calculate a threshold for removing features of the explainability vector. In some embodiments, the threshold may correspond to a pre-set real number, e.g., 0.45. In other embodiments, Feature Extraction Subsystem 116 may simply remove the bottom 10% of features ranked by values in the explainability vector. Using the threshold, Feature Extraction Subsystem 116 may add features to the subset of features to be removed. Feature Extraction Subsystem 116 may apply a mathematical transformation to the explainability vector such that values corresponding to the subset of features are adjusted. For example, the values in the explainability vector for the subset of features may be set to zero, or the values may be halved.

In addition to the removal and transformation of features described above, Feature Extraction Subsystem 116 may combine features with reference to Explainability Vector 134. For example, it may select features with low values in Explainability Vector 134 and map one or more such features into one combined feature. Feature Extraction Subsystem 116 may, for example, multiply the absolute values for three features to generate one new feature. Alternatively, Feature Extraction Subsystem 116 may determine whether all three feature values exceed thresholds for each and create a new feature which outputs 1 if all values are above their respect thresholds, and outputs 0 otherwise. In some embodiments, Feature Extraction Subsystem 116 may use the correlation matrix attached with Explainability Vector 134 to determine which features to combine. In some embodiments, the system may use a deep neural network to learn weights and combination rules for Feature Extraction Subsystem 116 using Explainability Vector 134 as an input.

The system may use an encoding map to translate the first set of features into a second set of features. Using the second set of features, the system may generate an approximate signature associated with each user profile. The approximate signatures may be processed using a clustering algorithm into a plurality of clusters.

At step 410, process 400 (e.g., using one or more components described above) may generate a set of categories based on the subset of features. Of the set of categories, one category may correspond to each textual prediction explanation. Each category may be assigned a range of real values. The ranges of real values may, in some embodiments, overlap to allow for a user profile being assigned to more than one textual prediction explanation. In other embodiments, the real value ranges of categories are mutually exclusive, indicating that each user profile is assigned to one textual prediction explanation.

At step 412, process 400 (e.g., using one or more components described above) may generate a hash table including the set of categories. The hash table may be indexable using a hash value generated based on values for the subset of features. The system may generate a hash table (e.g., Hash Table 136) including the set of categories. The hash table may be indexable using a hash value generated based on values for the subset of features for a user system. The hash values may be used to identify a category from the set of categories with which the user profile may be associated. To generate Hash Table 136, which may include rules on translating input features into hash values, the system may transform the subset of features into signatures in a real-valued vector space. The encoding map may be a series of rules and transformations that take a vector of values for the subset of features, applies mathematical transformations like weight multiplications and Boolean combinations to the vector of values, and produces an output vector (e.g., a signature corresponding to the input vector of values). For example, an input vector of the values [23, 0.7, 100, 66, 80.4] may be taken into an encoding map. The encoding map may multiply the first feature by 1.774 to obtain the first output value. The encoding map may determine whether the second feature is greater than 0.5: if it is, the second output value is set to 1 and if not, it is set to 0. The encoding map may calculate a difference between the third and fourth features (e.g., 34) to be the third output value. The encoding map may ignore the fifth feature. Thus, the encoding map in this example takes an input vector of [23, 0.7, 100, 66, 80.4] and outputs a signature [40.802, 1, 34]. The system may use an encoding map to transform the first plurality of user profiles into a plurality of signatures in the real-valued vector space. In some embodiments, random permutations may be performed on the plurality of signatures. For example, a vector of random noise terms may be generated by drawing from statistical distributions. The vector of random noise terms may be added or multiplied to the plurality of signatures to generate a plurality of approximate signatures. In some embodiments, the system may randomly choose one or more terms from a signature to generate an approximate signature consisting only of those terms.

The system may then compare the plurality of approximate signatures. Since all approximate signatures are in the same real-valued space, the system may compute a distance (e.g., Euclidean distance or cosine similarity) between one or more pairs of approximate signatures. The system may record a distribution of distances between approximate signatures. The system may select a distance threshold, for example, as a percentile in the distribution of distances. The system may compute measures of similarity between each pair of approximate signatures as being, for example, inversely proportional to the distance between the pair. The system may then compare measures of similarity against a similarity threshold (e.g., an inverse of the distance threshold) to arrange approximate signatures into clusters. In some embodiments, the selection of the similarity threshold may be performed by a clustering algorithm which automatically generates clusters using, for example, K-means computation. With each approximate signature assigned to a cluster among one or more clusters, each user profile may be assigned a hash value corresponding to the cluster.

The system may train an associative model to assign hash values to user profiles using their approximate signatures. The model may take as input a vector of values for the subset of features for a user profile (the feature vector), an approximate signature corresponding to the user profile, a cluster that the user profile's approximate signature was assigned to, and measures of similarity between the approximate signature and other approximate signatures. The associative model may output a hash value which falls into the real-value range of a category in the set of categories. The associative model may be trained on supervised training data from real applications of the system in generating textual prediction explanations. For example, for a user profile corresponding to a particular set of inputs, the correct category to place the user profile into had a hash value range of [0.887, 0.996]. During model training, any hash value output by the associative model between [0.887, 0.996] may be treated as a correct prediction. In some embodiments, the system may use more precise standards of accurate prediction when training the associative model. For example, the system may train the associative model using a loss function capturing the distance of the output from the center of the hash value range of the correct category. The associative model may use an algorithm like linear regression, random forest, naïve Bayes, among other algorithms.

At step 414, process 400 (e.g., using one or more components described above) may transmit to a user system a notification comprising a textual prediction explanation. The system may transmit a notification to a user device corresponding to a user profile. The notification may contain a pre-generated message explaining the prediction results of the first machine learning model, using the category of the set of categories the user profile was assigned to. In some embodiments, the notification may contain a plurality of textual prediction explanations, all of whose corresponding categories the user profile was assigned to.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method for using a hash table for generating a textual prediction explanation for an executed instruction, comprising: receiving, for a first plurality of user systems, a first plurality of user profiles and a corresponding plurality of resource availability values, wherein each user profile includes values for a first set of features; using values for the first set of features from the first plurality of user profiles and the corresponding plurality of resource availability values, training a first machine learning model to determine resource availability for a user system, wherein the first machine learning model receives as input values for the first set of features and generates as output a corresponding resource availability value; processing the first machine learning model to extract an explainability vector, wherein each entry in the explainability vector corresponds to a feature in the first set of features and is indicative of a correlation between the feature and the output of the first machine learning model; using the explainability vector, selecting from the first set of features a subset of features having corresponding values in the explainability vector above a threshold; generating a set of categories based on the subset of features, wherein each category in the set of categories corresponds to one or more textual prediction explanations for the output of the first machine learning model; generating a hash table including the set of categories, wherein the hash table is indexable using a hash value generated based on values for the subset of features for a user system; and for a user profile processed using the first machine learning model to generate a corresponding resource availability value, transmitting to a user system corresponding to the user profile a notification comprising a textual prediction explanation retrieved from the hash table using a hash value generated based on values of the subset of features from the user profile.

2. A method for generating a textual prediction explanation for an executed instruction, comprising: receiving, for a first plurality of user systems, a first plurality of user profiles and a corresponding plurality of resource availability values, wherein each user profile includes values for a first set of features; processing a first machine learning model to extract an explainability vector, wherein the first machine learning model receives as input values for the first set of features and generates as output a corresponding resource availability value; using the explainability vector, selecting from the first set of features a subset of features having corresponding values in the explainability vector above a threshold; generating a set of categories based on the subset of features, wherein each category in the set of categories corresponds to one or more textual prediction explanations for the output of the first machine learning model; generating a hash table including the set of categories, wherein the hash table is indexable using a hash value generated based on values for the subset of features for a user system; and for a user profile processed using the first machine learning model to generate a corresponding resource availability value, transmitting to a user system corresponding to the user profile a notification comprising a textual prediction explanation retrieved from the hash table using a hash value generated based on values of the subset of features from the user profile.

3. A method, comprising: receiving, for a first plurality of user systems, a first plurality of user profiles and a corresponding plurality of resource availability values, wherein each user profile includes values for a first set of features; selecting from the first set of features a subset of features based on a threshold; generating a set of categories based on the subset of features, wherein each category in the set of categories corresponds to one or more textual prediction explanations; generating a hash table including the set of categories, wherein the hash table is indexable using a hash value generated based on values for the subset of features for a user system; and for a user profile, transmitting to a user system corresponding to the user profile a notification comprising a textual prediction explanation retrieved from the hash table using a hash value generated based on values of the subset of features from the user profile.

4. The method of any one of the preceding embodiments, wherein generating a hash table including the set of categories comprises: generating a transformation algorithm which encodes the subset of features into signatures in a real-valued vector space; using the transformation algorithm to encode feature values of the first plurality of user profiles into a plurality of signatures in the real-valued vector space; performing random permutations on the plurality of signatures to determine a plurality of approximate signatures; generating measures of similarity between approximate signatures for user profiles in the first plurality of user profiles; calculating a threshold for similarity in the real-valued vector space; using a clustering algorithm to identify groups of user profiles with measures of similarity for each pair of user profiles within the groups of user profiles exceeding the threshold for similarity; and assigning each user profile a hash value based on a group of user profiles closest to the user profile.

5. The method of any one of the preceding embodiments, further comprising: receiving a vector of hash values for the first plurality of user profiles; retrieving the set of categories, wherein each category in the set of categories corresponds to one or more textual prediction explanations; training an associative model to correlate each hash value with a category in the set of categories; and generating a hash table such that each hash value corresponds to a category with a highest correlation between the hash value and the category.

6. The method of any one of the preceding embodiments, wherein processing the first machine learning model to extract the explainability vector comprises: retrieving a first set of parameters for the first machine learning model; selecting an attribution technique based on the first set of parameters and the first plurality of user profiles; and applying the attribution technique to the first set of parameters to generate the explainability vector corresponding to the first set of features.

7. The method of any one of the preceding embodiments, wherein selecting a subset of features from the first set of features further comprises: receiving a user request specifying that one or more features be removed from consideration or that impact of the one or more features be reduced; calculating a threshold for removing features of the explainability vector; and applying a mathematical transformation to the explainability vector such that values corresponding to the one or more features are adjusted.

8. The method of any one of the preceding embodiments, wherein: the first machine learning model is defined by a set of parameters comprising a matrix of weights for a multivariate regression algorithm; and the attribution technique applied to the set of parameters defining the first machine learning model is the Shapley Additive Explanation method.

9. The method of any one of the preceding embodiments, wherein: the first machine learning model is defined by a set of parameters comprising a matrix of weights for a supervised classifier algorithm; and the attribution technique applied to the set of parameters defining the first machine learning model is the Local Interpretable Model-agnostic Explanations method.

10. The method of any one of the preceding embodiments, wherein: the first machine learning model is defined by a set of parameters comprising a matrix of weights for a convolutional neural network algorithm; and the attribution technique applied to the set of parameters defining the first machine learning model is the Gradient Class Activation Mapping method.

11. The method of any one of the preceding embodiments, wherein: the first machine learning model is defined by a set of parameters comprising a hyperplane matrix for a support vector machine algorithm; and the attribution technique applied to the set of parameters defining the first machine learning model is the counterfactual explanation method.

What is claimed is:

1. A system for using a hash table for generating a textual prediction explanation for an executed instruction, the system comprising:
receiving, for a first plurality of user systems, a first plurality of user profiles and a corresponding plurality of resource availability values, wherein each user profile includes values for a first set of features;
using values for the first set of features from the first plurality of user profiles and the corresponding plurality of resource availability values, training a first machine learning model to determine resource availability for a user system, wherein the first machine learning model receives as input values for the first set of features and generates as output a corresponding resource availability value;
processing the first machine learning model to extract an explainability vector, wherein each entry in the explainability vector corresponds to a feature in the first set of features and is indicative of a correlation between the feature and the output of the first machine learning model;
using the explainability vector, selecting from the first set of features a subset of features having corresponding values in the explainability vector above a threshold;
generating a set of categories based on the subset of features, wherein each category in the set of categories corresponds to one or more textual prediction explanations for the output of the first machine learning model;
generating a hash table including the set of categories, wherein the hash table is indexable using a hash value generated based on values for the subset of features for a user system; and
for a user profile processed using the first machine learning model to generate a corresponding resource availability value, transmitting to a user system corresponding to the user profile a notification comprising a textual prediction explanation retrieved from the hash table using a hash value generated based on values of the subset of features from the user profile.

2. A method for generating a textual prediction explanation for an executed instruction, the method comprising:
receiving, for a first plurality of user systems, a first plurality of user profiles and a corresponding plurality of resource availability values, wherein each user profile includes values for a first set of features;
processing a first machine learning model to extract an explainability vector, wherein the first machine learning model receives as input values for the first set of features and generates as output a corresponding resource availability value;
using the explainability vector, selecting from the first set of features a subset of features having corresponding values in the explainability vector above a threshold;
generating a set of categories based on the subset of features, wherein each category in the set of categories corresponds to one or more textual prediction explanations for the output of the first machine learning model;
generating a hash table including the set of categories, wherein the hash table is indexable using a hash value generated based on values for the subset of features for a user system; and
for a user profile processed using the first machine learning model to generate a corresponding resource availability value, transmitting to a user system corresponding to the user profile a notification comprising a textual prediction explanation retrieved from the hash table using a hash value generated based on values of the subset of features from the user profile.

3. The method of claim 2, wherein generating a hash table including the set of categories comprises:
generating a transformation algorithm which encodes the subset of features into signatures in a real-valued vector space;
using the transformation algorithm to encode feature values of the first plurality of user profiles into a plurality of signatures in the real-valued vector space;
performing random permutations on the plurality of signatures to determine a plurality of approximate signatures;
generating measures of similarity between approximate signatures for user profiles in the first plurality of user profiles;
calculating a threshold for similarity in the real-valued vector space;
using a clustering algorithm to identify groups of user profiles with measures of similarity for each pair of user profiles within the groups of user profiles exceeding the threshold for similarity; and
assigning each user profile a hash value based on a group of user profiles closest to the user profile.

4. The method of claim 3, further comprising:
receiving a vector of hash values for the first plurality of user profiles;
retrieving the set of categories, wherein each category in the set of categories corresponds to one or more textual prediction explanations;
training an associative model to correlate each hash value with a category in the set of categories; and
generating a hash table such that each hash value corresponds to a category with a highest correlation between the hash value and the category.

5. The method of claim 2, wherein processing the first machine learning model to extract the explainability vector comprises:
retrieving a first set of parameters for the first machine learning model;
selecting an attribution technique based on the first set of parameters and the first plurality of user profiles; and
applying the attribution technique to the first set of parameters to generate the explainability vector corresponding to the first set of features.

6. The method of claim 5, wherein selecting a subset of features from the first set of features further comprises:
receiving a user request specifying that one or more features be removed from consideration or that impact of the one or more features be reduced;
calculating a threshold for removing features of the explainability vector; and
applying a mathematical transformation to the explainability vector such that values corresponding to the one or more features are adjusted.

7. The method of claim 5, wherein:
the first machine learning model is defined by a set of parameters comprising a matrix of weights for a multivariate regression algorithm; and
the attribution technique applied to the set of parameters defining the first machine learning model is a Shapley Additive Explanation method.

8. The method of claim 5, wherein:
the first machine learning model is defined by a set of parameters comprising a matrix of weights for a supervised classifier algorithm; and
the attribution technique applied to the set of parameters defining the first machine learning model is a Local Interpretable Model-agnostic Explanations method.

9. The method of claim 5, wherein:
the first machine learning model is defined by a set of parameters comprising a matrix of weights for a convolutional neural network algorithm; and
the attribution technique applied to the set of parameters defining the first machine learning model is a Gradient Class Activation Mapping method.

10. The method of claim 5, wherein:
the first machine learning model is defined by a set of parameters comprising a hyperplane matrix for a support vector machine algorithm; and
the attribution technique applied to the set of parameters defining the first machine learning model is a counterfactual explanation method.

11. A non-transitory computer-readable medium comprising instructions that, when executed by one or more processors, cause operations comprising:
receiving, for a first plurality of user systems, a first plurality of user profiles and a corresponding plurality of resource availability values, wherein each user profile includes values for a first set of features;
selecting from the first set of features a subset of features based on a threshold;
generating a set of categories based on the subset of features, wherein each category in the set of categories corresponds to one or more textual prediction explanations;
generating a hash table including the set of categories, wherein the hash table is indexable using a hash value generated based on values for the subset of features for a user system; and
for a user profile, transmitting to a user system corresponding to the user profile a notification comprising a textual prediction explanation retrieved from the hash table using a hash value generated based on values of the subset of features from the user profile.

12. The non-transitory computer-readable medium of claim 11, wherein the operations further comprise:
processing a first machine learning model to extract an explainability vector, wherein the first machine learning model receives as input values for the first set of features and generates as output a corresponding resource availability value; and
using the explainability vector, selecting from the first set of features the subset of features having corresponding values in the explainability vector above the threshold.

13. The non-transitory computer-readable medium of claim 12, wherein generating a hash table including the set of categories comprises:
generating a transformation algorithm which encodes the subset of features into signatures in a real-valued vector space;
using the transformation algorithm to encode feature values of the first plurality of user profiles into a plurality of signatures in the real-valued vector space;
performing random permutations on the plurality of signatures to determine a plurality of approximate signatures;
generating measures of similarity between approximate signatures for user profiles in the first plurality of user profiles;
calculating a threshold for similarity in the real-valued vector space;
use a clustering algorithm to identify groups of user profiles with measures of similarity for each pair of user profiles within the groups of user profiles exceeding the threshold for similarity; and
assigning each user profile a hash value based on a group of user profiles closest to the user profile.

14. The non-transitory computer-readable medium of claim 13, further comprising:
receiving a vector of hash values for the first plurality of user profiles;
retrieving the set of categories, wherein each category in the set of categories corresponds to one or more textual prediction explanations;
training an associative model to correlate each hash value with a category in the set of categories; and
generating a hash table such that each hash value corresponds to a category with a highest correlation between the hash value and the category.

15. The non-transitory computer-readable medium of claim 12, wherein processing the first machine learning model to extract the explainability vector comprises:
retrieving a first set of parameters for the first machine learning model;
selecting an attribution technique based on the first set of parameters and the first plurality of user profiles; and
applying the attribution technique to the first set of parameters to generate the explainability vector corresponding to the first set of features.

16. The non-transitory computer-readable medium of claim 15, wherein selecting a subset of features from the first set of features further comprises:
receiving a user request specifying that one or more features be removed from consideration or that impact of the one or more features be reduced;
calculating a threshold for removing features of the explainability vector; and
applying a mathematical transformation to the explainability vector such that values corresponding to the one or more features are adjusted.

17. The non-transitory computer-readable medium of claim 15, wherein:
the first machine learning model is defined by a set of parameters comprising a matrix of weights for a multivariate regression algorithm; and
the attribution technique applied to the set of parameters defining the first machine learning model is a Shapley Additive Explanation method.

18. The non-transitory computer-readable medium of claim 15, wherein:
the first machine learning model is defined by a set of parameters comprising a matrix of weights for a supervised classifier algorithm; and
the attribution technique applied to the set of parameters defining the first machine learning model is a Local Interpretable Model-agnostic Explanations method.

19. The non-transitory computer-readable medium of claim 15, wherein:
the first machine learning model is defined by a set of parameters comprising a matrix of weights for a convolutional neural network algorithm; and
the attribution technique applied to the set of parameters defining the first machine learning model is a Gradient Class Activation Mapping method.

20. The non-transitory computer-readable medium of claim 15, wherein:
the first machine learning model is defined by a set of parameters comprising a hyperplane matrix for a support vector machine algorithm; and
the attribution technique applied to the set of parameters defining the first machine learning model is a counterfactual explanation method.
